(19) United States
(12) Patent Application Publication
(10) Pub. No.: US 2017/0293215 A1
(43) Pub. Date: Oct. 12, 2017

(54) PORTABLE THEATER

(71) Applicant: Richard W. Clapp, Grand Haven, MI (US)

(72) Inventor: Richard W. Clapp, Grand Haven, MI (US)

(21) Appl. No.: 15/471,006

(22) Filed: Mar. 28, 2017

Related U.S. Application Data
(60) Provisional application No. 62/320,948, filed on Apr. 11, 2016.

(51) Int. Cl. G03B 29/00; H04N 9/31; G03B 21/16; G03B 31/00; G03B 21/14

(52) U.S. Cl. CPC G03B 29/00; G03B 31/00; G03B 21/145; G03B 21/16; G03B 21/142; H04N 9/3144

(57) ABSTRACT

A portable entertainment and viewing system includes a mobile base that is configured to support a display projector and audiovisual components. The system provides a portable and protective outdoor entertainment system to display motion pictures, photograph slideshows, or movies. The system is simple to setup and lightweight compared to typical portable motion picture viewing systems, such that the system can be quickly moved indoors and outdoors, and protects the components from various elements, such as wind, rain, and dirt. The projector is operable on the base and the audiovisual components are operable within the base. The system includes a coupling that is fixed to the base, which couple the projector to the audiovisual components that are within the base.

### CROSS-REFERENCE TO RELATED APPLICATION

This application claims priority from U.S. application Ser. No. 62/320,948, filed on Apr. 11, 2016, the disclosure of which is hereby incorporated herein by reference in its entirety.

### FIELD OF THE INVENTION

The present invention relates to a portable device for presenting motion pictures.

### SUMMARY OF THE INVENTION

The present invention provides a portable entertainment and viewing system. According to one aspect of the present invention, a portable viewing system includes a mobile base that is configured to support a display projector and audiovisual components. A coupling is fixed to the base, which couples the projector to the audiovisual components. The projector is operable on the base and the audiovisual components are operable within the base.

Another aspect of the invention is a portable viewing system that includes a mobile base, a display projector that is operable on or from the base, an audiovisual component operable within the base to provide an audiovisual signal to the display projector, and a coupling that is fixed to the base. The coupling is configured to couple the projector to the audiovisual components, wherein the audiovisual component provides the audiovisual signal to the display projector at least when the audiovisual component is sealed within the base.

Therefore, the present invention provides a portable and protective outdoor entertainment system to display motion pictures, photograph slideshows, or movies. The system is configured to be simple to setup and lightweight compared to typical portable motion picture viewing systems, such that the system can be quickly moved indoors and outdoors as necessary, and protects the components from various elements, such as wind, rain, and dirt.

These and other objects, advantages, purposes and features of the present invention will become apparent upon review of the following specification in conjunction with the drawings.

### BRIEF DESCRIPTION OF THE DRAWINGS

FIG. 1 is a perspective view of a portable theater system with a projector on a base in accordance with the present invention;

FIG. 2A is a photograph of a movie projected onto an outdoor surface by the portable theater system of FIG. 1;

FIG. 2B is a photograph of the portable theater system with a projector on a base of FIG. 1, in which system is outdoors and projecting the movie of FIG. 2A for viewers, and the system is coupled to external speakers, in accordance with the present invention;

FIG. 3 is a rear perspective view of the portable theater system of FIG. 1, showing a coupling, a pair of wheels, and handle;

FIG. 4 is a front perspective view of the portable theater system of FIG. 1;

FIG. 5A is the rear perspective view of the portable theater system of FIG. 3;

FIG. 5B is a top view of audiovisual components secured in a storage portion of the portable theater system of FIG. 1;

FIG. 6A is another front perspective view of the portable theater system;

FIG. 6B is another rear perspective view of the portable theater system of FIG. 3;

FIG. 6C is another photograph of the portable theater system projecting the movie of FIG. 2A for viewers onto a viewing surface in accordance with the present invention;

FIG. 7 is a side view of a portable theater system in accordance with another aspect of the invention, with a projector lifting mechanism;

FIG. 8 is a front view of the portable theater system of FIG. 7;

FIG. 9A is a perspective view of the portable theater system of FIG. 7 with the projector lifting mechanism raised; and

FIG. 9B is a perspective view of the portable theater system of FIG. 7 with the projector lifting mechanism lowered.

### DESCRIPTION OF THE PREFERRED EMBODIMENTS

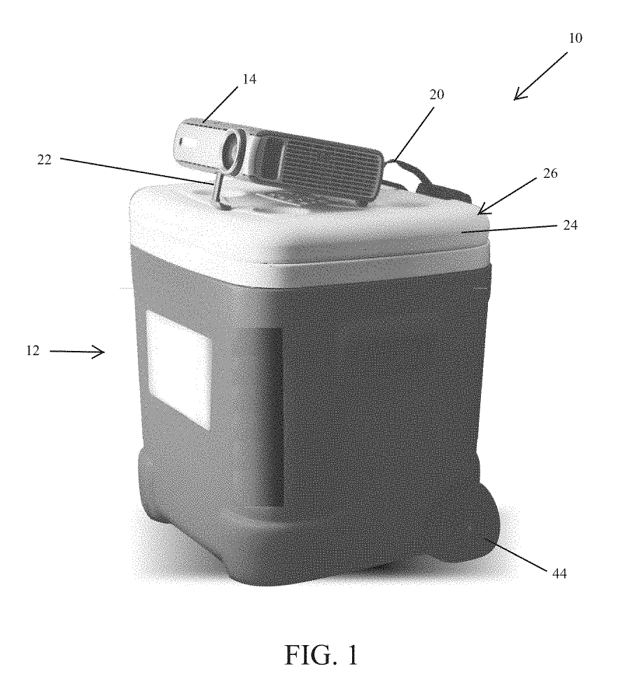

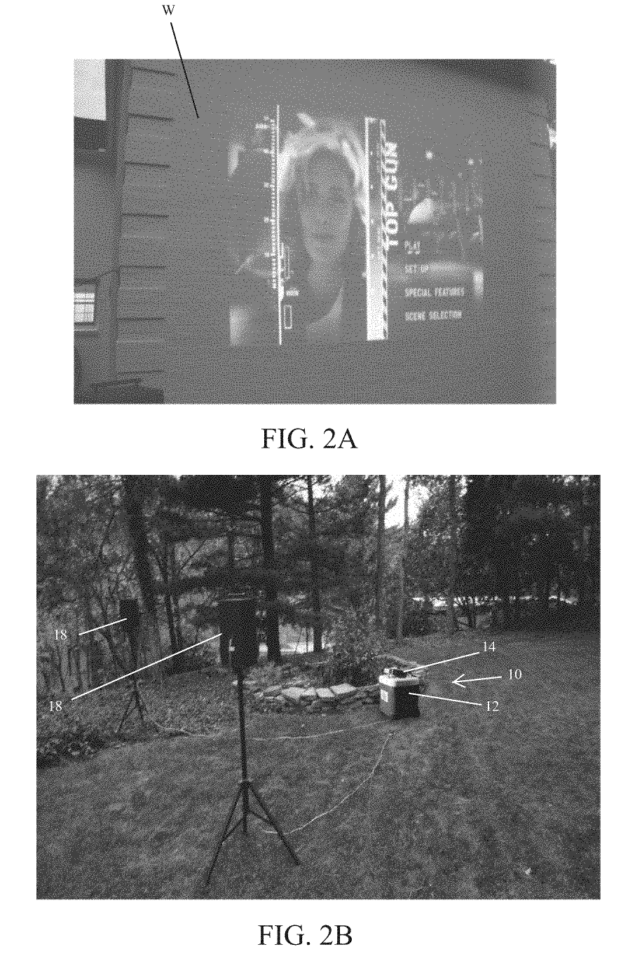

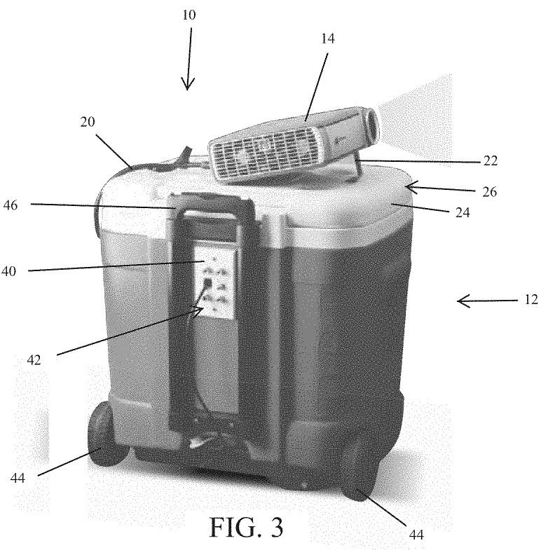

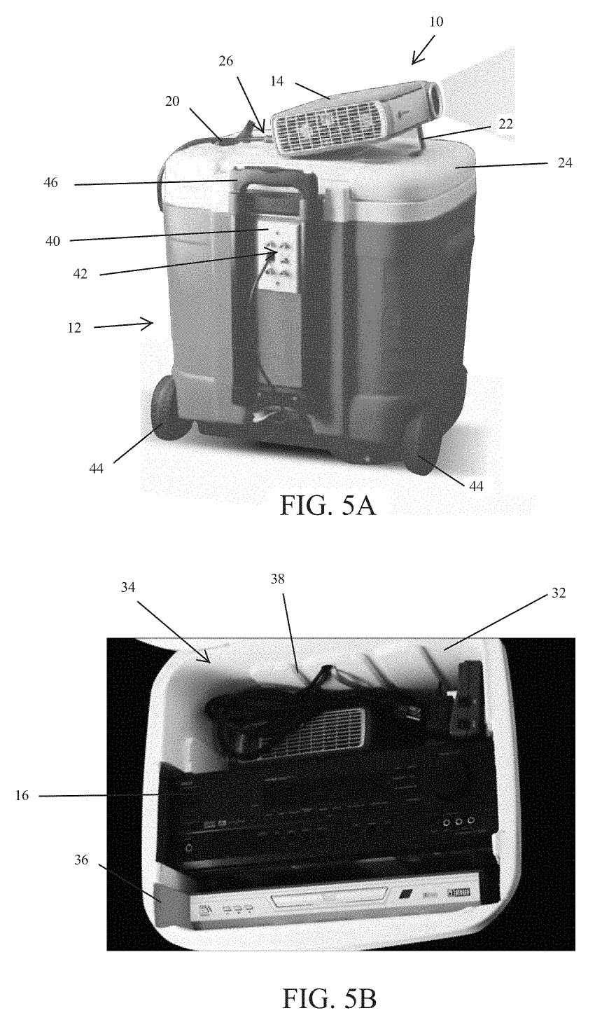

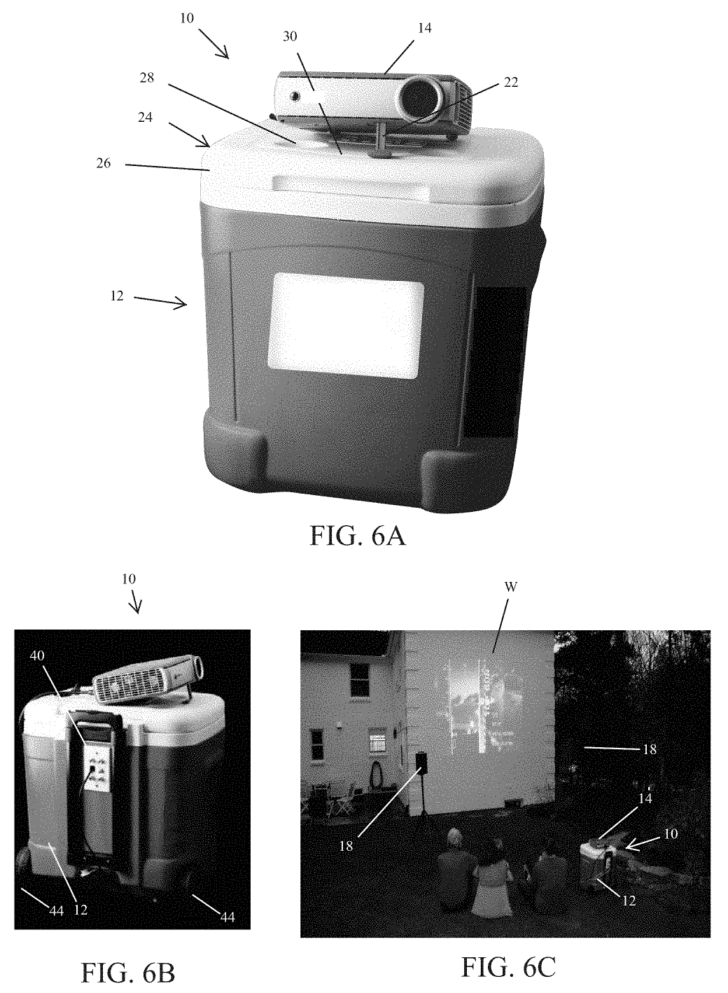

The present invention is a system to transport, store, and operate a portable motion picture viewing system 10. For example, the system 10 (FIGS. 1-9B) may be used to display motion pictures, photograph slideshows, or movies on viewing surfaces W, such as portable screens or fixed walls, at outdoor recreational events, such as picnics, tailgates, camping, barbecues, parties, gatherings, and the like (see FIGS. 2A and 6C). In particular, the system 10 is configured to be simple to setup and lightweight compared to typical portable motion picture viewing systems, such that the system 10 can be quickly moved indoors and outdoors as necessary. The system 10 includes a storage portion 12 and audiovisual equipment. The storage portion 12 is configured to securely store and transport the viewing equipment from location to location. The audiovisual equipment generally includes audiovisual electronics for viewing motion pictures and movies, including a projector 14, audiovisual components 16, like a video player (such as a DVD or Blu-Ray player) and receiver, speakers 18, and accompanying electrical and audiovisual signal cables 20 (see FIG. 5A). Other electronic devices may also be included, such as VHS players, power storage devices (e.g. electric batteries), and the like.

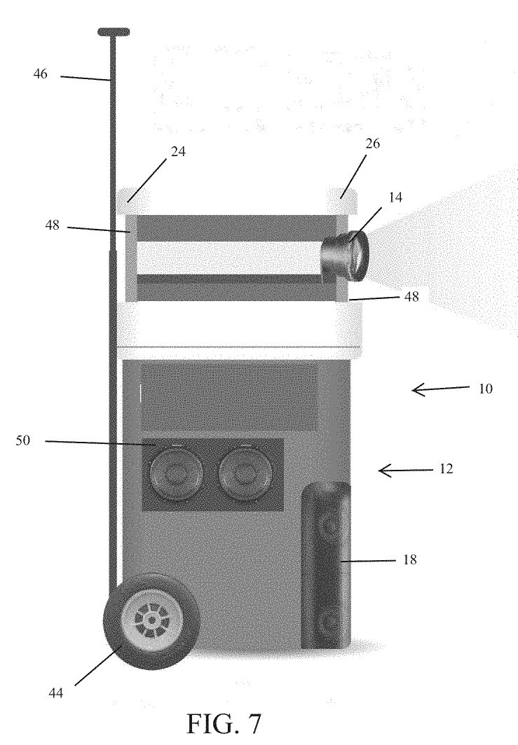

The projector 14 of the illustrated embodiment is a typical video projector that receives a signal from the audiovisual components 16, and displays the video on the viewing surface W, as directed. The projector 14 includes an adjustable leg 22 adjusts the projector's 14 tilt and orientation with respect to the viewing surface W to optimize the video image for viewers. The projector 14 may be controlled by a remote control, by the audiovisual components, or the like. In another aspect of the present invention, a video display 52 (FIGS. 7-9B) is fixed to the storage portion 12 and can also be used, such as via a touch screen, to control the system 10 and to display motion pictures from the audiovisual components 16. The projector 14 of the illustrated embodiment is configured to display motion pictures on the viewing surface W at a brightness of about 2000 lumens or greater and resolution of about 1080p or greater, and play audio, such as via 50 Watt speakers, which is configurable by an on-board audio mixer.

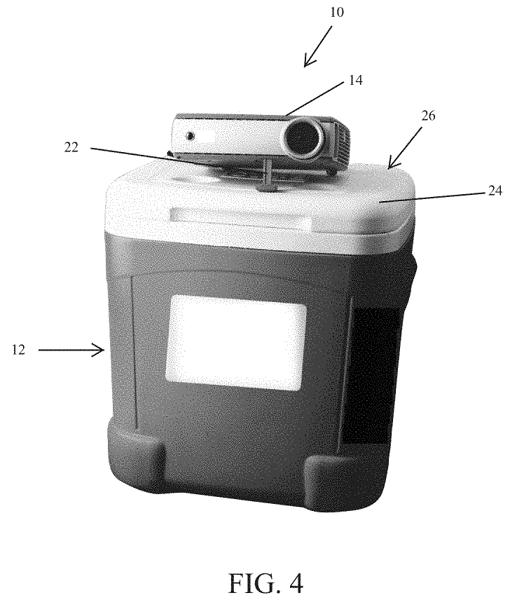

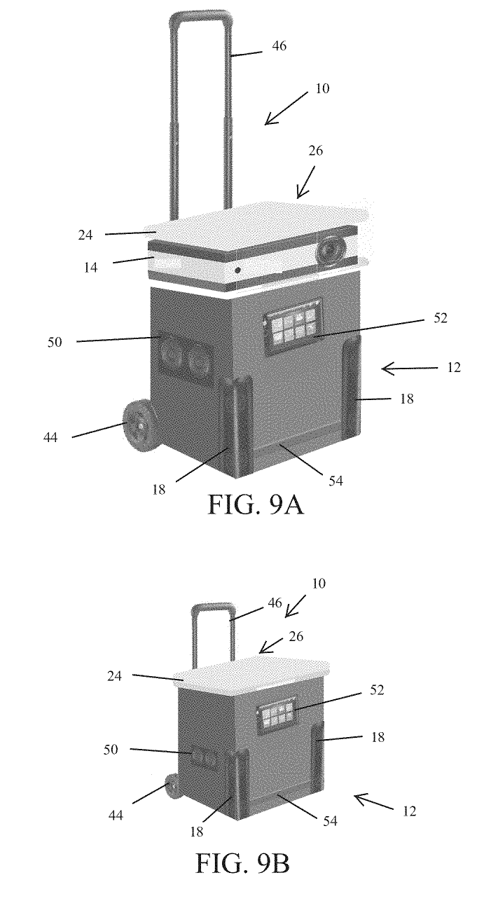

Referring now to FIG. 4, the audiovisual components 16 and components of the illustrated embodiment provide video and audio playback capabilities to the projector 14 and speakers 18. For example, the audiovisual components 16 are typical devices that may have additional features to increase usability of the system 10, such as wireless connections, Internet connections (e.g. Wi-Fi® or Ethernet), wired auxiliary connections, FM/AM radio, and the like. The wireless connections may include Bluetooth® and Wi-Fi®, for example, to further connect wireless speakers to the system 10, and to support video and audio inputs from portable devices, such as smartphones, laptops, tablet computers, removable storage such as SD cards (see FIG. 9A) and the like. The portable devices may also connect to the system 10 via the wired auxiliary connections. Furthermore, the audiovisual components 16 of the illustrated embodiment may connect typical microphones to the system such that the system can be used for public announcements or karaoke.

In another aspect of the present invention, the speakers 18 are formed to the storage portion 12 (FIGS. 7-9B), and removable to be placed in proper orientation to the audience. The speakers 18 may also include a subwoofer 50 formed in the outside of the storage portion 12 to produce low-frequency sounds.

The storage portion 12 of the illustrated embodiment is closed by a lid 24 that is configured to support the projector 14. The lid 24, which is has a top surface 26 that has a width and length for the projector 14 to rest on the top without hanging off of the lid 24. The lid 24 is openable with a hinge (see FIG. 5B) or vertically actuable to store the projector 14 (see FIGS. 7-9B), as described below. The lid 24 has features that increase the usability of the lid 24, including cup holders 28 for holding beverages and supporting indentations 30 (FIG. 6A), which the projector 14 may rest in to restrict the projector's 14 movement on the lid 24 if the system 10 is bumped or slightly tilted when in use. The indentations 30 also supports the adjustable leg 22 of the projector when the leg 22 is extended from the projector 14 to tilt the projector 14. Thus, the lid 24 provides a stable base on which to rest the projector 14 to display motion pictures and movies at outdoor recreational events. Optionally, the lid 24 may have mounting features that fasten the projector 14 to the top of the lid 24 to further the projector's 14 movement on the lid 24.

Referring to FIGS. 7, 8, and 9A-B, the projector 14, according to one aspect of the present invention, is mountable to an interior side of the lid 24 and vertically actuatable to store the projector within the storage portion 12. A set of lifting mechanisms or actuators 48 raise and lower the lid 24 and mounted projector 14 to operate the projector 14. For example, the front of the lid 24 rises to show the projector 14, and the rear of the lid 24 is open to allow access to the storage cavity 32 of the storage portion 12. The set of actuators are configured to store the projector 14 within the storage portion 12 when it is not in use, and orient the projector 14 to the screen or viewing surface W with minimal effort. Thus, the actuators 48 decrease the setup time of the system 10 and increases the protection of the projector 14 from environmental elements.

The storage portion 12 has a storage cavity 32 that is insulated and waterproof to protect the audiovisual components 16, from external elements, such as wind, rain, hail, dirt, and the like. The storage cavity 32 may be constructed with double-walls to increase the insulation. However, the storage cavity 32 may be constructed with single-walls and the like. The storage cavity 32 is accessible through a sealable top opening 34 (FIG. 5B) that is openable and closable by the lid 24. In the illustrated embodiment, the storage cavity 32 is shaped as a rectangular box with substantially flat sides, however, the storage cavity 32 may be other shapes, such as cylindrical or spherical. The audiovisual components 16 are fixed to at least two sides of the storage cavity 32 by interference fittings or typical rack systems to reduce damage to the components while transporting the system 10. The interference fittings of the illustrated embodiment include indentations 36 (FIG. 5B) that are formed or cut into the sides. Each audiovisual component 16 is frictionally engaged to and/or fastened to the indentations 36. Optionally, the audiovisual components 16 can be accessed and operable from one of the sides of the storage portion 12. In another aspect of the invention, the storage cavity 32 also includes a portion of cold storage that is separated from the audiovisual components 16, for example, to store cold beverages and food. Such a storage cavity can have a separate compartment or area for providing insulated storage for ice, food, and/or beverage and the like, such that the storage cavity may have a drainage opening for emptying water from melted ice. Further, an integrated fan may optionally be provided to circulate cold area, such as from the cold storage, to the audiovisual component.

The system 10 is configured to electrically couple the audiovisual components 16 that are inside the storage cavity to devices that are external to the storage cavity 32 via a cable port 38 and a distribution panel 40, or coupling, while protecting the audiovisual components 16 from external elements. The cable port 38 is formed in one of the sides of the storage cavity 32 to allow electrical and signal cables 20 from the audiovisual components 16 from inside the storage cavity 32 to the exterior. The distribution panel 40 includes an interior portion that is adjacent to the cable port 38, and an exterior portion 42 that is coupled to the outside of the storage portion 12 and is exposed to the outside environment.

Electrical power sources, such as a home A/C power source (e.g. using extension cables) or a D/C power source (e.g. a twelve-volt source, such as a cigarette lighter, from an automotive vehicle) with an AC/DC power inverter, and signal cables 20 couple to the system 10 at the exterior portion 42, such as at the distribution panel 40. Alternatively, the electrical power sources may directly couple to the projector 14 and audiovisual components 16. Optionally, the system may include integrated batteries, such as lithium ion type batteries, to provide power to the system, such as when an electrical power source is not available. These batteries can be rechargeable by an integrated battery charger, via an integrated A/C power cord that will also be able to power the system. The interior portion includes internal electrical power connections and signal connections that correspond to the external electrical power connections and signal cables 20 on the exterior portion 42 of the distribution panel 40. In addition, the system 10 can also include power outlets, such as typical A/C outlet to power external devices. Thus, the system 10 allows the audiovisual components 16 within the storage cavity 32 to couple to external systems while protecting the audiovisual components 16.

The storage portion 12 is further configured to increase the portability of the system 10 by including wheels 44 and a handle 46. The illustrated embodiment includes two wheels 44, mounted adjacent to the handle 46, to allow the system 10 to roll along surfaces, and stably rest on adjustable feet to level the system relative to the screen or viewing surface W, when placed in a given location. The handle 46 telescopes between inward and outward positions to not interfere with the projector 14 when it is projecting onto the viewing surface W, or interfere with the lid 24 when it is open. The outside of the storage portion may also include molded handles to grasp when lifting or moving the system 10. The storage portion 12 of the illustrated embodiment includes double-walled construction, as discussed above, and is formed of plastic to have low weight, high durability, and insulation and waterproof characteristics. However, the system 10 may be formed of other materials, such as metal, wood, and the like.

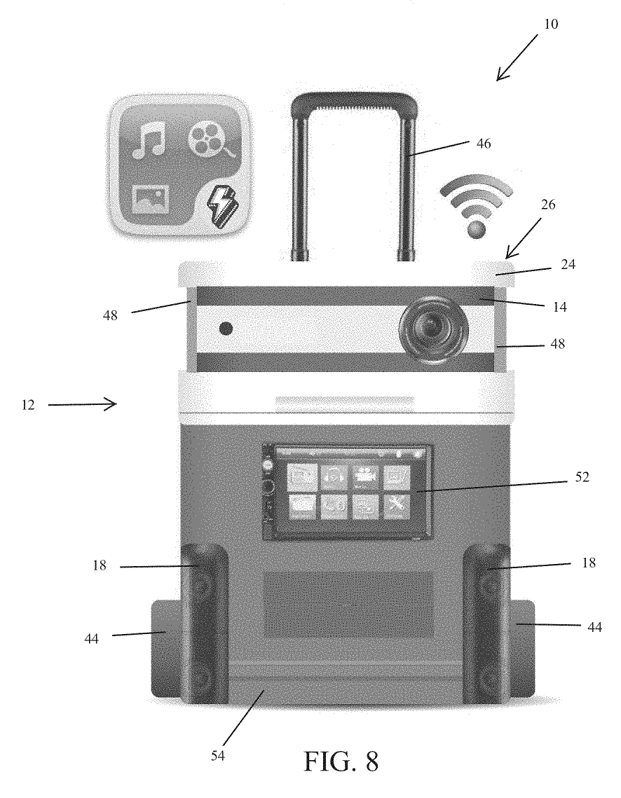

In addition, another aspect of the illustrated embodiment includes a storage drawer 54 (FIGS. 8, 9A-B) at the base of the storage portion 12. The storage drawer 54 stores objects that are used with the system 10, such as signal cables 20, the remote control, and A/C power extension cables and/or D/C power cables (e.g. male cigarette lighter plugs), when not in use. The outside of the storage portion 12 may also include accent and ambient lighting, for example, to accent the color of the system 10, such as LED ground effect lighting that glow towards the base of the system 10.

Accordingly, the system 10 of the present invention is an outdoor entertainment system to display motion pictures, photograph slideshows, or movies. The system 10 is configured to be simple to setup and lightweight compared to typical portable motion picture viewing systems, such that the system 10 can be quickly moved indoors and outdoors as necessary, and protects the components from various elements, such as wind, rain, and dirt.

Changes and modifications in the specifically-described embodiments may be carried out without departing from the principles of the present invention, which is intended to be limited only by the scope of the appended claims as interpreted according to the principles of patent law including the doctrine of equivalents.

The embodiments of the invention in which an exclusive property or privilege is claimed are defined as follows:

1. A portable viewing system, comprising:
a mobile base configured to support a display projector at an upper portion of said mobile base and audiovisual components at an interior portion of said mobile base; and
a coupling fixed to said mobile base that is configured to couple said display projector to said audiovisual components,
wherein, when said display projector is operable at said mobile base and said audiovisual components are operable within said mobile base, said coupling couples said projector on said mobile base to said audiovisual components within said mobile base.

2. The portable viewing system of claim 1, wherein said interior portion of said mobile base is sealable from outdoor elements.

3. The portable viewing system of claim 2, wherein said coupling is configured to couple said display projector to said audiovisual components when said interior portion of said mobile base is sealed from outdoor elements.

4. The portable viewing system of claim 1, wherein said mobile base insulates said audiovisual components at said interior portion of said mobile base.

5. The portable viewing system of claim 1, wherein said mobile base comprises wheels and a handle configured to facilitate transportation of said portable viewing system.

6. The portable viewing system of claim 1, wherein said portable viewing system is operable to connect to wireless devices.

7. The portable viewing system of claim 1, wherein said upper portion of said mobile base includes a cover that is configured to receive said display projector.

8. A portable viewing system, comprising:
a mobile base;
a display projector operable on or inside said mobile base;
an audiovisual component operable within said mobile base to provide said display projector with an audiovisual signal; and
a coupling fixed to said mobile base that is configured to couple said display projector to said audiovisual component,
wherein said audiovisual component provides said audiovisual signal to said display projector at least when said audiovisual component is sealed within said mobile base.

9. The portable viewing system of claim 8, wherein said mobile base insulates said audiovisual component.

10. The portable viewing system of claim 8, wherein said mobile base comprises a set of wheels and a handle configured to facilitate transportation of said portable viewing system.

11. The portable viewing system of claim 8, wherein said audiovisual component is operable to connect to wireless devices to further provide audiovisual signals to said display projector.

12. The portable viewing system of claim 8, wherein said mobile base includes a lifting mechanism that is operable to displace said display projector from said mobile base for positioning a lens portion of said display projector at a desired projection location.

13. The portable viewing system of claim 8, wherein said audiovisual component is disposed in an interior compartment of said mobile base that is sealable from outdoor elements with a cover portion of said mobile base.

14. The portable viewing system of claim 13, wherein said cover portion of said mobile base is configured to support said display projector when operating said display projector and said audiovisual component.

15. The portable viewing system of claim 14, wherein said mobile base insulates said audiovisual component at said interior compartment of said mobile base, and wherein said interior compartment of said mobile base includes a portion that is configured to insulate and store food or beverages.

16. The portable viewing system of claim 15, wherein said mobile base includes a cooling system fan that is configured to transfer air within the interior compartment to the audio visual component.

17. A portable viewing system, comprising:
a mobile base;
an audiovisual component coupled with said mobile base and configured to provide a display projector operable on said mobile base with an audiovisual signal; and
a lifting mechanism coupled with said mobile base and operable to displace said display projector from said mobile base,
wherein said audiovisual component provides said audiovisual signal to said display projector at least when said audiovisual component is sealed within said mobile base.

18. The portable viewing system of claim 17, wherein said lifting mechanism is operable to displace said display projector from said mobile base to position a lens portion of said display projector at a desired projection location.

19. The portable viewing system of claim 17, wherein said audiovisual component is disposed in an interior compartment of said mobile base that is sealable from outdoor elements.

20. The portable viewing system of claim 17, further comprising a coupling fixed to said mobile base that is configured to couple said display projector to said audiovisual component.
